(19) United States
(12) Patent Application Publication
(10) Pub. No.: US 2017/0087037 A1
(43) Pub. Date: Mar. 30, 2017

(54) SEAT OR PART THEREOF

(71) Applicants: Rouand James Mortimer SCARLETT, Onehunga, Auckland (NZ); Roydon Mark SCARLETT, Mangere Bridge, Auckland (NZ)

(72) Inventors: Rouand James Mortimer SCARLETT, Onehunga, Auckland (NZ); Roydon Mark SCARLETT, Mangere Bridge, Auckland (NZ)

(21) Appl. No.: 15/310,512

(22) PCT Filed: Apr. 20, 2015
(86) PCT No.: PCT/NZ2015/000030

§ 371 Date: Nov. 11, 2016

(30) Foreign Application Priority Data
May 13, 2014 (NZ) 624937

(51) Int. Cl. A61G 5/12; A61G 5/10

(52) U.S. Cl. CPC A61G 5/122; A61G 5/121; A61G 5/1056; A61G 5/1091

(57) ABSTRACT

A torso support for a seat, having: a padding base 2; an outer link 3; an inner link 4; a U shaped clamp 6; a release button 5; a pivot pin 7; and a seat attachment bracket 8. The inner link 4 has a space housing the button 5. The button 5 can be pressed so it pivots between locking and unlocking dispositions. When in the locking disposition, the inner edge 13 of the button is close to a short arm of the clamp so they are almost abutting. This prevents the inner link 14 pivoting because to move in that way would cause a clash between the inner edge of the clamp 6 and the button 5.

### FIELD OF INVENTION

This invention relates to a seat or part thereof. A preferred form of the invention relates to a wheelchair or stationary seat, or part thereof, which can be adjusted for use with those in need of special care, although it should be understood that the invention is not limited to this.

### BACKGROUND

In the context of caring for people with physical disabilities it is known to employ a seat which can be adjusted to suit a user's needs. It is an object of a preferred form of the invention to go at least some way towards facilitating this. While this is the object of a preferred embodiment, it should be understood that the object of the invention per se is simply to provide the public with a useful choice.

### SUMMARY OF THE INVENTION

According to one aspect of the invention there is provided a torso support for a seat having:
an outer support;
a central link;
a seat attachment; and
locking means;
   the central link and seat attachment being pivotable with respect to one another to enable the torso support to be angle adjusted when in use to enable adjustment of the outer support, characterised in that the locking means (e.g. a button or lever, etc) can be moved between locked and unlocked positions, the arrangement being such that when the locking means is in a locked position it is so close to the seat attachment that attempted pivoting movement of the central link with respect to the seat attachment causes a locking clash between the locking means and the seat attachment, and such that when the locking means is in the unlocked position there is no such clash so that such pivoting movement is enabled.

Preferably the seat attachment is connected to the central link by a pivot pin which allows the central link to pivot with respect to the seat attachment when the locking means is in the unlocked position.

Preferably the torso support has a U shaped clamp which wraps around the pivot pin and wherein one arm of that clamp extends further than the other to create a step which facilitates the clash.

Preferably the locking means comprises a button recessed in the central link.

Preferably the central link has a pair of arms which wrap around the pivot pin so that the central link can pivot with respect to the seat attachment when the locking means is in the unlocked position.

Preferably there is at least one outer link between the outer support and central link.

Preferably the central link has at least one slot which allows the outer support to slide for adjustment of the effective span of the torso support.

Preferably the seat attachment has at least one slot which allows it to slide when fastened to a seat back for adjustment of the effective span of the torso support.

Preferably the outer support is padded.

In a second aspect of the invention there is provided a seat incorporating a torso support as described in the first aspect of the invention.

In a further aspect of the invention there is provided a headrest for a seat comprising:
a head support;
a series of link arms; and
at least a pair of locking arms;
   the link arms being pivotable with respect to one another to enable adjustment of the head support and arranged such that the locking arms can be centrally locked with respect to one another to automatically lock the link arms against the pivotable movement.

Optionally the headrest is arranged such that:
a) the head support is capable of being adjusted in depth; and/or
b) the head support is at least partially padded; and/or
c) the locking arms can be locked with respect to one another by a locking screw or bolt; and/or
d) there is at least one inner locking arm and least one outer locking arm which overlap and both having slots in them adapted to receive a locking screw; and/or
e) the link arms comprise an outer link which pivotally connects to the head support, an inner link which pivotally connects to a backrest or frame of a seat and a medial link which pivotally connects to the inner and outer links; and/or
f) the medial link arm contains an aperture adapted to receive a/the locking screw or bit to enable locking of the link arms against pivotable movement; and/or
g) the headrest forms part of a seat.

In a further aspect of the invention there is provided a seat having:
a rigid base;
a plurality of studs;
a plurality of clamps; and
a support frame;
   the studs being adjustable with respect to the base to enable the base, when in use, to engage with the support frame, each clamp having a recess complementary to one of the studs so that, when in use, the clamps can be fastened to the frame and the studs inserted into the recesses to releasably lock the base with respect to the frame.

Optionally the seat is arranged such that:
a) the clamps have means to releasably lock the studs to the clamps; and/or
b) the rigid base has a plurality of holes and/or slots to allow the studs to be adjustably attached to the base; and/or
c) the studs have a generally mushroom head shape

In a further aspect of the invention there is provided a mounting bracket having:
a generally L-shaped plate;
an adjustment plate which is angle adjustable with respect to the L-shaped plate;
a clamp plate releasably engageable with the adjustment plate; and
a clamp secured to the clamp plate;
   wherein clamp plate has a notched portion at each end adapted to engage with pins proceeding from the attachment plate and one of the notched portions can pivot to enable the clamp plate and the clamp to be secured to the rest of the bracket, the clamp being adapted to be releasably engaged with a pole forming part of the support structure of a chair.

Optionally the seat bracket is arranged such that:
a) the adjustment plate has slots to allow it to be adjusted with respect to the L-shaped plate; and/or
b) the L-shaped plate has slots to allow it to be adjusted with respect to a backrest and/or the adjustment plate; and/or
c) the mounting bracket is secured to a backrest and the backrest has vertical slots in it to allow the bracket to be adjusted with respect to the backrest.

In a further aspect of the invention there is provided a backrest for a seat having:
a mounting panel;
seat attachments secured to the mounting panel; and
a cover panel;
   the seat attachments giving rise to protrusions between the mounting and cover panels, and the cover panel arranged to avoid pressure points due to such protrusions on padding in front of the cover panel.

Optionally the backrest is arranged such that:
a) the mounting panel has a plurality of apertures to enable the seat attachments to be adjustably attached; and/or
b) the mounting panel is generally concave; and/or
c) the mounting panel is in 3 generally planar portions; and/or
d) the cover panel has means (e.g. Velcro™)) to enable attachment of padding; and/or
e) the backrest has clamping brackets for holding the backrest to a frame of the seat; and/or
f) the backrest forms part of a seat.

### BRIEF DESCRIPTION OF DRAWINGS

Some preferred embodiments of the invention will now be described by way of example and with reference to the accompanying drawings, of which:

FIG. 1 is a perspective view of a torso support;

FIG. 2 is a reverse perspective view of the torso support;

FIG. 3 is a perspective view of a U clamp and pivot pin forming part of the torso support;

FIG. 4 is a side view of a headrest;

FIG. 5 is a perspective view of a seat base;

FIG. 6 is a perspective view of the underside of the seat base;

FIG. 7 is a perspective view of a seat clamp;

FIG. 8 is a perspective view of four of the seat clamps;

FIG. 9 is a perspective view of a backrest, a pair of the torso supports and a pair of backrest mounting brackets;

FIG. 10 is a perspective view of part of the backrest and the backrest mounting bracket;

FIG. 11 is a perspective view showing detail of a clamp and clamp plate forming part of the backrest mounting bracket;

FIG. 12 is a perspective view showing detail of a L-shaped plate and an adjustment plate forming part of the backrest mounting bracket;

FIG. 13 is a perspective view of the backrest incorporating a backrest cover panel, a pair of the torso supports and a pair of backrest mounting brackets; and

FIG. 14 is a perspective view of an alternative embodiment of a torso support.

### DETAILED DESCRIPTION

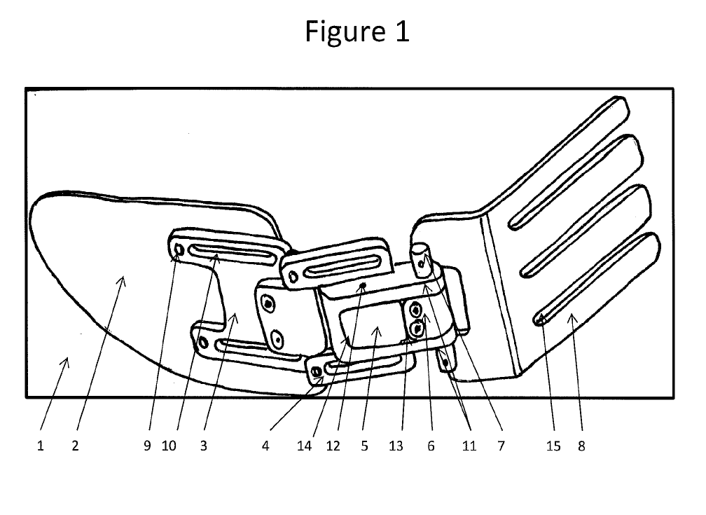

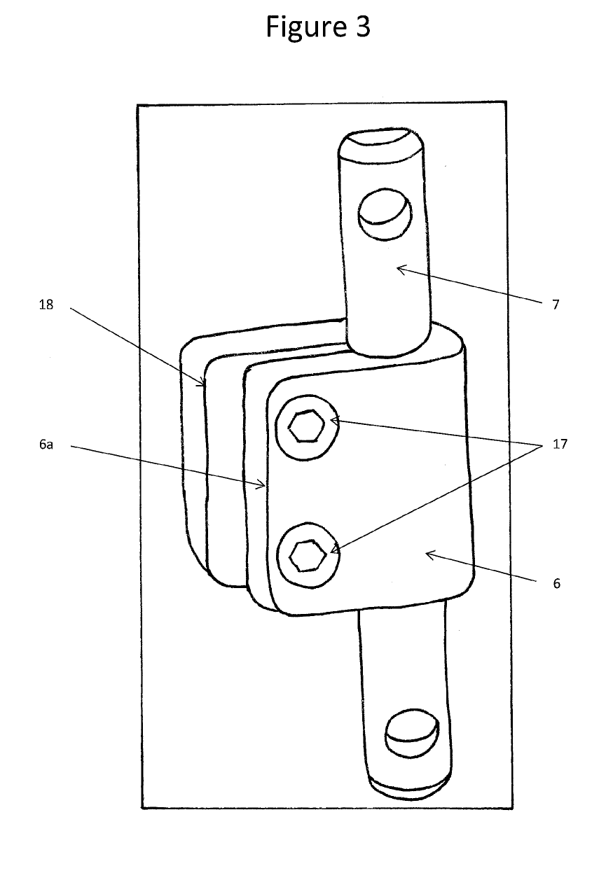

FIG. 1 shows a torso support 1 which forms parts of a wheelchair seat to provide postural support and stability to the user's trunk. A similar arrangement may be used for stationary seats intended for people with special postural care needs. Two of the supports 1 are used, one at each side of the wheelchair. These supports 1 are adjustable and ensure that the user's trunk is supported correctly to facilitate an upright seating posture, etc. The support 1 has a padding base 2, an outer link 3, an inner link 4, a release button 5, a U shaped clamp 6 (shown in more detail in FIG. 3), a pivot pin 7 and a chair attachment bracket 8.

The padding base 2 is connected to the outer link 3 by fasteners such as bolts or the like. The fasteners pass through slots 10 leaving holes 9 free to secure a cushion/padding. The slots 10 allow the padding base 2 to be slid laterally with respect to the link 3 so the length of the torso support 1 can be adjusted. In some embodiments the padding base 2 can also have slots (not shown) to allow for length adjustment. In alternative embodiments there can be more than one of the outer links 3, joined in a chain for extra reach, and in some embodiments there is no outer link 3 and the padding base 2 is attached directly to the inner link 4.

In the embodiment shown the padding base 2, outer link 3 and the inner link 4 are not themselves padded although in some embodiments one or all of them may be padded. The outer link 3 is connected to the inner link 4 by a locking pin (not visible). The inner link 4 has a pair of arms 11 which wrap around the pin 7 which enables the link 4 to pivot around it for angle adjustment.

The link 4 has a space housing the button 5. The button 5 is rectangular and is slightly recessed to reduce the risk of someone accidently pressing it. The button 5 is spring loaded and is attached to the link 4 by a pin, indicated at 12, which is attached to the centre of the button 5. The button 5 can be pressed at one end to pivot about this pin 12 in a see-saw fashion, but is biased by its spring to have a non-pivoted disposition.

In the FIG. 1 embodiment the button 5 is in a locking disposition i.e. it is not depressed. When the button 5 is in this locking state the inner edge 13 of the button 5 is very close to a short arm 6a (see FIG. 3) of the clamp 6, so they are almost abutting. This prevents the inner link 4 from pivoting around the pin 7 because pivoting of the inner link 4 with respect to the clamp 6/pin 7/bracket 8 is prevented by a clash between the inner edge 13 of the button 5 and the short arm 6a.

When the button 5 is depressed at its outer side 14 it pivots around the pin 12 and comes away from the short arm 6a of the clamp 6. This allows the inner link 4, the attached outer link 3 and padding base 2 to pivot collectively with respect to the pin 7/bracket 8. When the button 5 is released the spring (not visible) urges the button 5 back to its locking position.

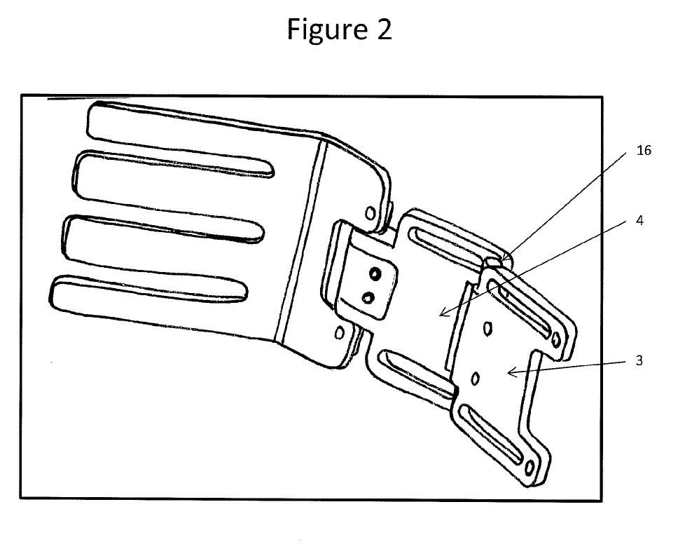

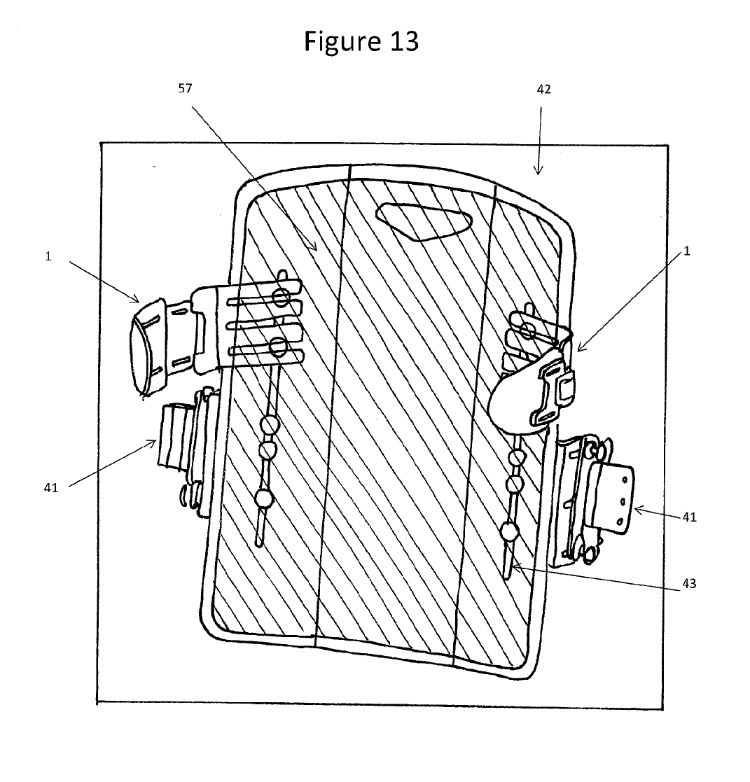

Referring to FIG. 3, the clamp 6 is wrapped around and tightened to the pin 7 by fasteners (not show), which is in turn attached by way of fasteners to the chair attachment bracket 8. Referring to FIGS. 1 and 2, the bracket 8 contains a number of slots 15 for fasteners to pass through and fasten the bracket to a backrest of the wheelchair (see FIG. 13). These slots 15 also allow the bracket 8 to slide in and out for adjustment of the effective span of the torso support 1.

As shown in FIG. 2, the outer link 3 is connected to the inner link 4 by a pin 16 The pin 16 is fastened to the back of the inner link 4 and runs rough an aperture (not visible) therein. The pin 16 enables the outer link 3 to pivot with respect to the inner link 4 for good angle adjustment, optionally with a similar button arrangement to that described above.

Referring to FIG. 3, the clamp 6 has a pair of apertures 17 in which fasteners can be used to lock the clamp with respect to the pin 7. This means that in use the clamp 6 and pin 7 turn in unison. As shown, there is a step created as one end 18 of the clamp extends further than the other 6a. As indicated above, when the button 5 is in its normal resting/locking state and a user tries to turn the inner link 4 with respect to the pin 7, the button's inner edge 13 clashes with the step and this prevents the inner link 4 from pivoting about the pin 7.

It will be appreciated of the torso support may function as an arm rest, hip guide, etc. In further embodiments of the invention there may be more than one torso support 1 at each side of the seat. For example there may be two torso supports 1 for each side, and for each side they may be adjusted to have a different size and shape so as to provide customised support for the user.

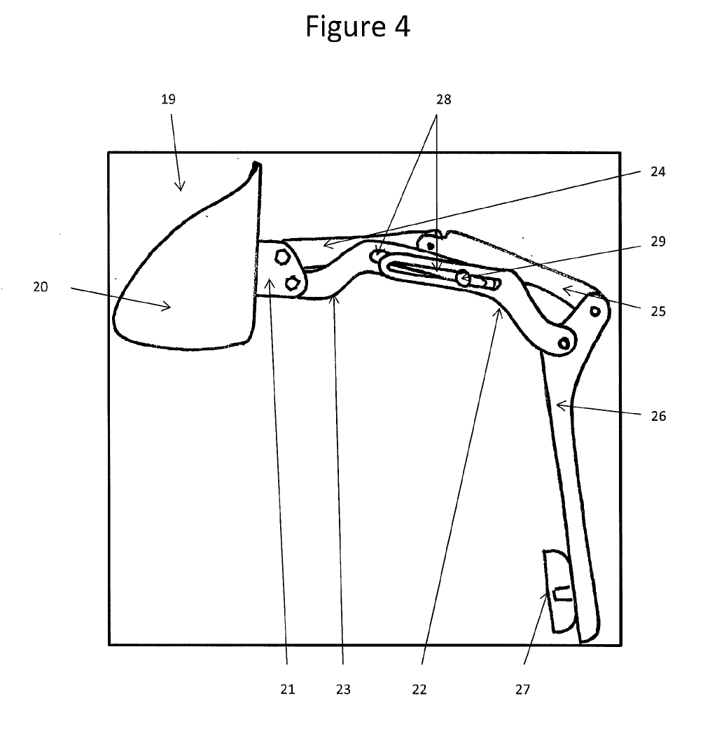

FIG. 4 shows a headrest 19 of the wheelchair. It has a head shell 20, a shell attachment bracket 21, an inner locking arm 22 and an outer locking arm 23, an outer link 24, a medial link 25, an inner link 26 and a locking knob 27. The shell 20 is padded and provides support for a user's neck and head and, in some embodiments, the sides of the shell 20 can be adjusted in width and/or depth. The locking arm 22 and the outer link 24 are both connected to the bracket 21. The bracket 21 can pivot with respect to them to allow the shell 20 to be angle adjusted.

The inner locking arm 22 overlaps with the outer locking arm 23 and both have slots 28 which overlap. The slots 28 receive a locking screw (not visible) which can be set to lock the two arms with respect to one another in varying degrees of overlap.

The inner locking arm 22 is pivotally connected to an upper part of the inner link 26, The lower part of the inner link 26 is connected to a seat back via the locking knob 27 and its other end is pivotally connected to the medial link 25, The other end of the medial link 25 is pivotally connected to the outer link 24. The medial link 25 has an aperture 29 for receiving the locking screw mentioned above. The locking screw passes through the slots 28 of the locking arms 22, 23 and into the aperture 29. When the locking screw is tightened the inner, medial and outer links are therefore unable to pivot with respect to one another, so that the headrest is effectively locked in place. When the locking screw is loosened the height, depth, width and/or angle of the headrest 19 can be adjusted by pivoting the links 24, 25, 26. They can then be locked by the locking screw—i.e. at one place so that each pivot connection does not have to be locked individually.

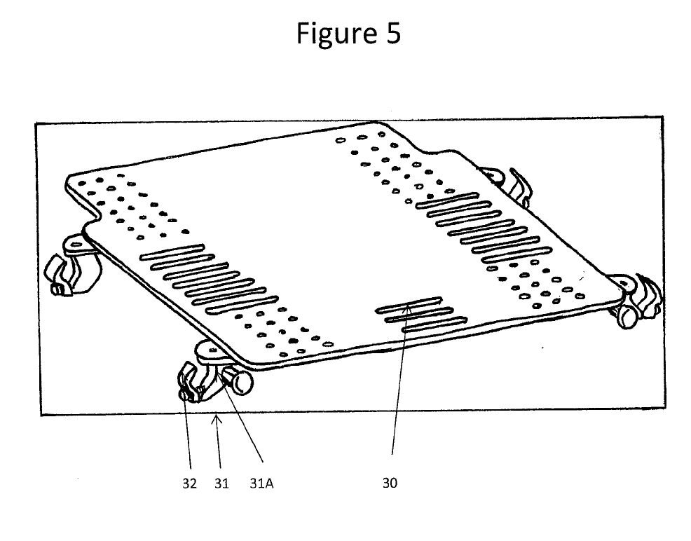

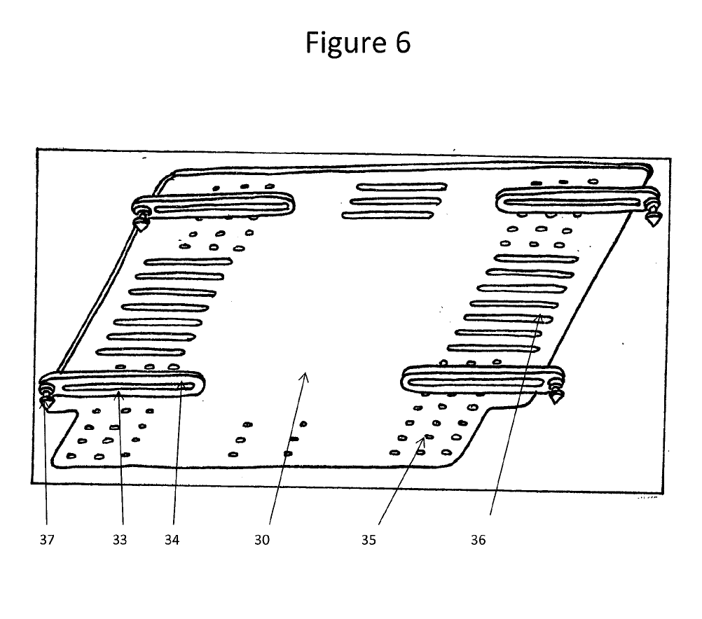

FIG. 5 shows a seat base 30, i.e. to support one's posterior, with clamps 31 suitable for clamping onto the poles that make up the main supportive structure of the wheelchair. The clamps 31 have two parts, an inner part 31 A and an outer part 32, and are fastened together. As shown in FIG. 6 the base 30 is connected to seat width adjustment brackets 33. These brackets 33 have slots 34 in them to receive locking screws. The base 30 also has an array of holes 35 and slots 36 to receive locking screws. The bracket 33 is connected to the base 30 by locking screws, and the slots 34 allow the bracket 33 to slide with respect to the base 30, Attached to the ends of the brackets 33 are studs 37. As shown, the ends of the studs 37 have a mushroom like tip.

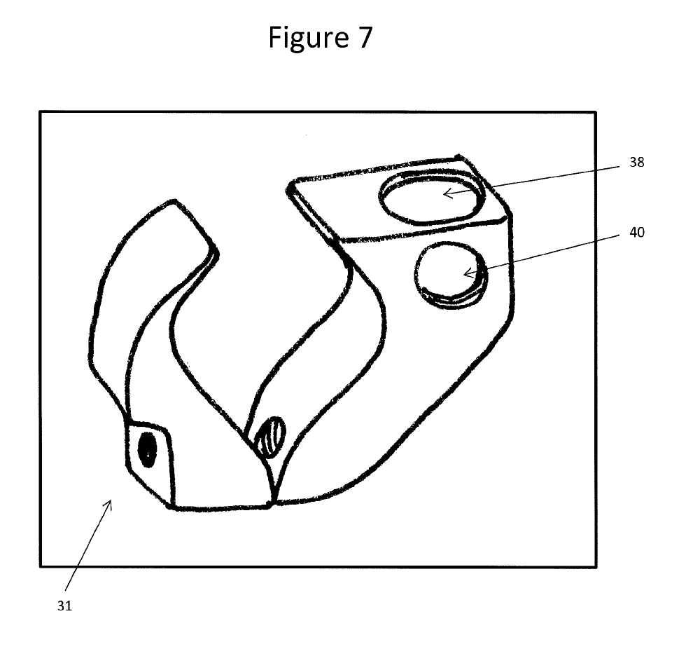

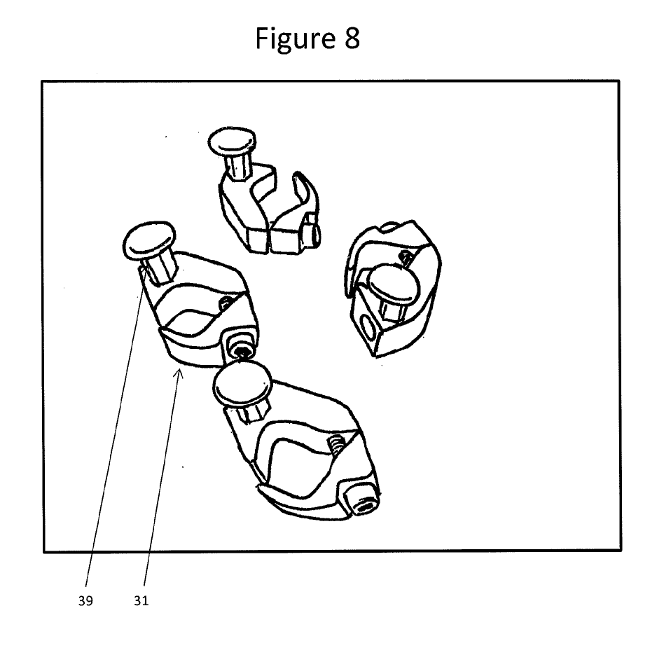

Referring to FIG. 7, each clamp 31 has a recess 38 to receive a corresponding one of the studs 37. FIG. 8 shows that the clamp 31 has a knob 39 for retracting a spring loaded locking pin (not visible). The locking pin extends laterally into the side of the recess 38 through an aperture 40 which is visible in FIG. 7. When the knob 39 is pulled outwards the locking pin allows the stud 37 to be inserted into the recess 38. Once the stud 37 has been inserted the knob 39 is released to cause the locking pin to lock the stud 37 in place. To remove the stud 37 pull the knob 39 is pulled outwards again. This mode of attachment is particularly useful for wheelchairs for chairs which collapse or disassemble for storage, or if the seat base is to be transferred from one wheel chair frame to another.

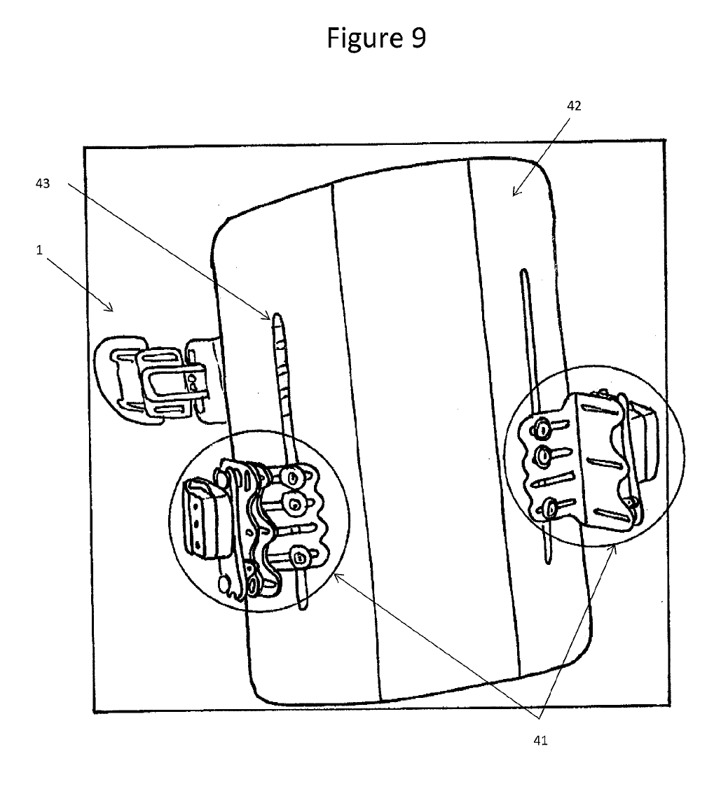

FIG. 9 shows a backrest mounting bracket 41 which can be used to adjust a backrest 42. The backrest 42 is made up of three substantially rigid panels having a generally concave shape, albeit that each panel is straight-lined, The backrest 42 has vertical slots 43 for fasteners to pass through and secure attachments such as the torso support 1 and mounting bracket 41.

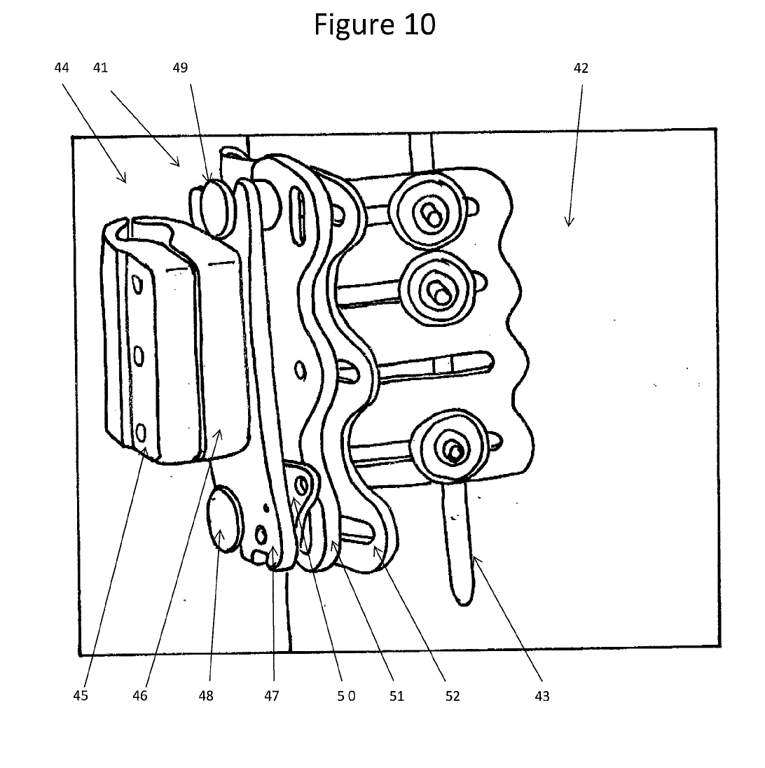

Referring to FIG. 10, the mounting bracket 41 comprises a clamp 44 having outer 45 and inner 46 jaws for clamping onto the poles that make up the main supportive structure of the wheelchair. The mounting bracket 41 also has a clamp plate 47, a lower 48 pin and upper pin 49, a backrest catch 50, an adjustment plate 51 and an L-shaped plate 52.

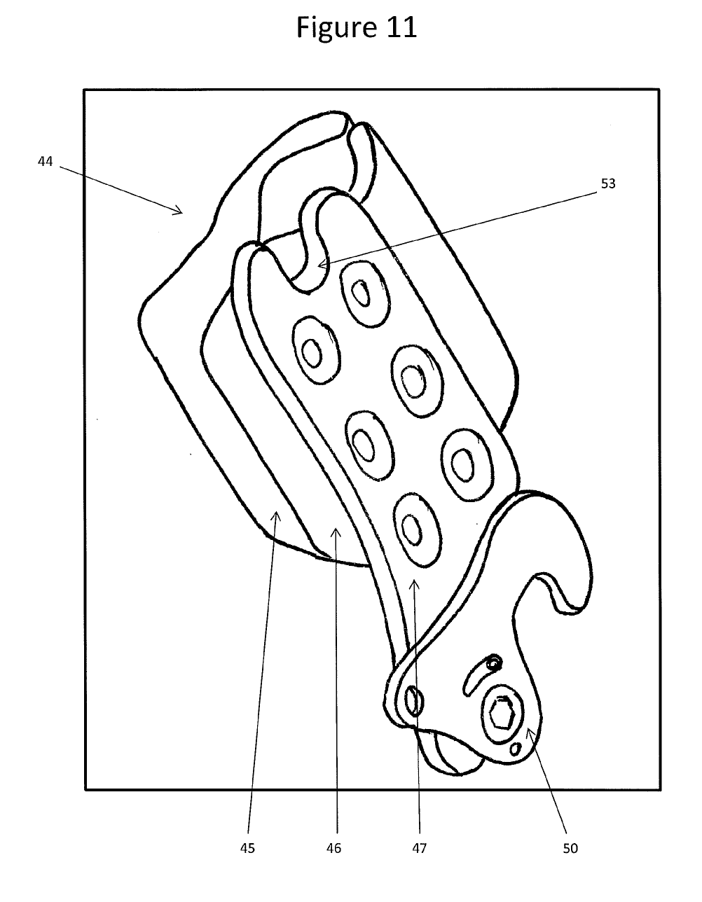

FIG. 11 shows the clamp 44 in more detail. The inner jaw 46 is fastened to both the outer jaw 45 and to the clamp plate 47. The inner jaw 46 and outer jaw 45 can be removed from the plate 47 and rotated 180 degrees and then reattached to the clamp plate 47. This enables the clamp 44 to be used in either the front or rear of a pole forming part of the support structure of a wheelchair. The plate 47 has a notch 53 which engages with the upper pin 49, The plate 47 also has a catch 50 which is spring loaded and engages with the lower pin 48, The clamp 44 and plate 47 can be detached from the rest of the bracket 41 by pivoting the catch 50 upwards. The arrangement is particularly useful for wheelchairs for example if the chair has to be folded for storage or if the backrest is transferred from one wheel chair frame to another.

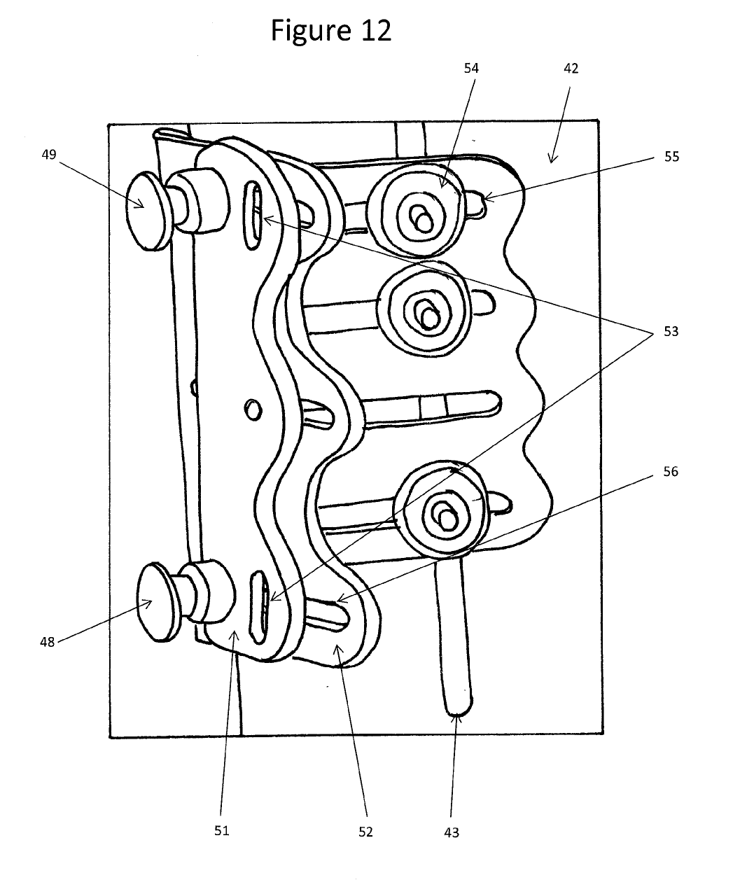

FIG. 12 shows the bracket 41 when the clamp 44 and plate 47 have been removed, The adjustment plate 51 is attached to the L-shaped plate 52. The plate 51 has slots 53 so the L-shaped plate 52 can be adjusted with respect to it. The L-shaped plate 52 is connected to the backrest 42 by way of fasteners 54. In the embodiment shown the backrest 42 has a vertical slot 43 through which the fasteners 54 pass through and fasten the backrest 42 to the L-shaped plate 52. This slot 43 also allows for the L-shaped plate to slide vertically with respect to the backrest 42 for height adjustment. The L-shaped plate 52 also has horizontal slots 55 so it can slide sideways with respect to the backrest 42 for width adjustment. The L-shaped plate also has number of slots 56 to enable it to be adjusted with respect to the plate 51.

FIG. 13 shows the backrest 42 with a pair of the torso supports 1, the backrest mounting brackets 41 and a cover panel 57. The panel 57 provides a smooth surface for receiving a cushion. This panel 57 is particularly useful as wheelchair backrests often have fasteners, or attachments fitted with screws or bolts and nuts etc, and these can protrude into a user's back and/or into padding and cause discomfort or wear. The panel 57 only covers the front of the backrest 42 and is attached to it at the top and centre positions, allowing for movement of the mounting bracket 41 and torso support 1 to continue behind it. In some embodiments the front surface of the panel 55 incorporates a hook and loop system, for example, Velcro™. This allows for items such as lumbar supports and other padding to be attached to the panel 55. In further embodiments the panel may be smaller in size and used to cover only certain parts of the backrest such as the slots 43.

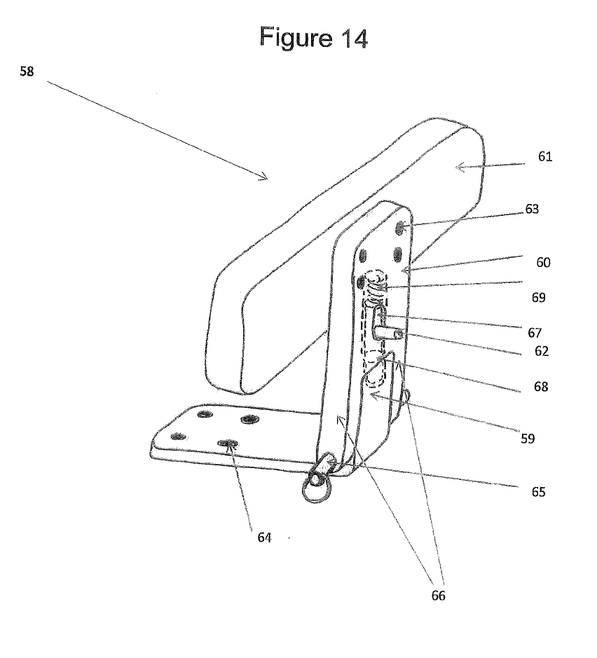

FIG. 14 shows a torso support 58 which attaches to a seat base (not visible). The support comprises an L-shaped plate 59, and upright plate 60, padding 61 and a locking lever 62, The bracket 60 has holes 63 for fasteners to pass through and secure the bracket 60 to the padding 61.

The L-shaped plate 59 also has holes 64 for fasteners so it can be secured to a seat base (not visible). The L-shaped plate 59 is attached to the plate 60 by a pivot pin 65 which passes through a hole (not visible) in the L-shaped plate 59. The plate 60 has a pair of arms 66 which wrap around the pin 65, These arms 66 enable the plate 60 to pivot about the pin 65 so that the plate 60 and padding can be swung to allow for easier access to the seat. When the pin 65 is removed, the plate 60 and attached padding 61 can be removed from the L-shaped plate 59.

The locking lever 62 is connected to a locking pin (not visible) which is housed within a recess 67 in the bracket 60. In the figure shown the lever 62 is in a locking disposition. When the lever 62 is in this locking state the pin extends into a recess 68 in the L-shaped plate 59. This prevents the bracket 60 from pivoting around the pin 65. When the lever 62 is pulled upwards the locking pin comes out of the recess 68 and this allows the bracket 60 attached padding 61 to pivot collectively with respect to the L-shaped plate 59. When the lever is released a spring 69 urges the lever 62 and pin back to its locking position. In some embodiments instead of a locking lever 62 the previously mentioned button locking arrangement shown in FIGS. 1-3 can be used instead.

While some preferred embodiments of the invention have been described by way of example it should be appreciated that modifications and improvements can occur without departing from the scope of the following claims.

1-28. (canceled)

29. A torso support for a seat having:
an outer support;
a central link;
a seat attachment; and
locking means comprising clash means and a pivoting button, the clash
means having two extending parts, one of the parts extending further than the other; the central link and seat attachment being pivotable with respect to one another to enable adjustment of the outer support, wherein the button can be moved between locked and unlocked positions, the arrangement being such that when the button is in a locked position the shorter extending part is so close to the button that attempted pivoting movement of the central link with respect to the seat attachment causes a locking clash between the shorter extending part and the button, and such that when the button is pivoted to the unlocked position there is no such clash so that such pivoting movement is enabled.

30. The torso support according to claim 29, wherein the seat attachment is connected to the central link by a pivot pin which allows the central link to pivot with respect to the seat attachment when the locking means is in the unlocked position.

31. The torso support according to claim 29, wherein the clashing means comprises a U shaped clamp which wraps around the pivot pin.

32. The torso support according to claim 29, wherein the locking means comprises a button recessed in the central link.

33. The torso support according to claim 30, wherein the central link has a pair of arms which wrap around the pivot pin so that the central link can pivot with respect to the seat attachment when the locking means is in the unlocked position.

34. The torso support according to claim 33, wherein there is at least one outer link between the outer support and central link.

35. The torso support according to claim 33, wherein the central link has at least one slot which allows the outer support to slide for adjustment of the effective span of the torso support.

36. The support according to claim 33, wherein the seat attachment has at least one slot which allows it to slide when fastened to a seat back for adjustment of the effective span of the torso support.

37. The torso support according to claim 29, wherein the outer support is padded.

38. The torso support according to claim 29, wherein:
a) the seat attachment is connected to the central link by a pivot pin which allows the central link to pivot with respect to the seat attachment when the locking means is in the unlocked position;
b) the clashing means comprises a U shaped clamp which wraps around the pivot pin;
c) the locking means comprises a button recessed in the central link;
d) the central link has a pair of arms which wrap around the pivot pin so that the central link can pivot with respect to the seat attachment when the locking means is in the unlocked position;
e) there is at least one outer link between the outer support and central link;
f) the central link has at least one slot which allows the outer support to slide for adjustment of the effective span of the torso support;
g) the seat attachment has at least one slot which allows it to slide when fastened to a seat back for adjustment of the effective span of the torso support; and
h) the outer support is padded.

39. A seat comprising a torso support according to claim 29.
